(19) United States
(12) Patent Application Publication
(10) Pub. No.: US 2006/0162982 A1
(43) Pub. Date: Jul. 27, 2006

(54) Device for recognising an obstacle underride

(76) Inventor: Thomas Lich, Schwaikheim (DE)

Correspondence Address: KENYON & KENYON LLP, ONE BROADWAY, NEW YORK, NY, 10004, US

(21) Appl. No.: 10/532,333

(22) PCT Filed: Oct. 18, 2003
(86) PCT No.: PCT/DE03/03500

§ 371 Date: Apr. 22, 2005

(30) Foreign Application Priority Data
Feb. 21, 2003 (DE) 10307463.5

(51) Int. Cl. B60K 28/00; B60R 21/01; B60R 21/34

(52) U.S. Cl. 180/271; 280/735

(57) ABSTRACT

A device for detecting an obstacle underride is situated on the vehicle front. The device detects an obstacle underride via a vertically positioned distance measuring device. Radar sensors, ultrasonic sensors, or video sensors may be used for distance measuring.

### BACKGROUND INFORMATION

An underride guard for a truck is described in U.S. Pat. No. 5,507,546. Such an underride guard has the disadvantage that it represents additional weight for the truck, resulting in less goods being able to be transported.

### SUMMARY OF THE INVENTION

The device according to the present invention for detecting an obstacle underride has the advantage over the related art that the vehicle itself, which actually underrides the obstacle, is able to detect this obstacle underride early using a distance sensor. This makes it possible to initiate protective measures already very early regarding the dangerous obstacle underride. The distance measuring device is only to be aligned essentially vertically. An alignment in the horizontal direction as well as in the vertical direction, or at any angle between the horizontal and the vertical, i.e., inclined, is also possible. In addition, devices for underride protection on trucks could be dispensed with, thereby omitting the additional weight.

It is particularly advantageous that the vertical distance measuring device has at least one transceiver. This transceiver may have ultrasound sensors or radar sensors. A Lidar system is also possible here. It is alternatively possible to use a video sensor.

A significant advantage is the fact that the distance measuring device is located on the bumper. This is the outermost part so that, due to the location of the vertical distance measuring device alone, a truck underride or another obstacle underride is detected very early. By using the distance measuring device, it is possible in particular to differentiate between a bridge underride and a truck underride since the distances are correspondingly different. The endangerment or triggering of protective measures for the vehicle occupants occurs at such a distance which could be hazardous due to the obstacle. The distance measurement may advantageously be carried out from different locations on the bumper distanced from one another.

Measuring errors may thus be corrected via a plausibility check, thereby also achieving greater accuracy.

The device according to the present invention is connectable to a control unit for restraint systems or restraining means, such as airbag, seat-belt tightener, roll bar, and the like, in such a way that the control unit triggers the restraining means as a function of a signal of the device, i.e., if, in the event of an obstacle underride, an obstacle is detected which could pose a danger to the vehicle occupants, the restraining means, providing the appropriate protection, are correspondingly triggered.

The device according to the present invention may also be configured for sensing pedestrians in particular. For this purpose, the device according to the present invention must be connected to different sensors in the front section of a vehicle. Since contact sensors or sensors known as prognostic sensors (pre-crash sensors) are predominantly used here, an unambiguous association with a pedestrian accident is needed. The device according to the present invention creates the advantage of differentiating a pedestrian from a struck obstacle such as a bumper of another vehicle, a parking post, or the like, thereby reducing the number of misuse cases and unnecessary repair costs. The device according to the present invention also being able to be integrated into the bumper area yields multiple benefits, a clear cost reduction, and increased functionality since existing control units may be used for data collection and an analysis may be performed if needed.

Moreover, there is the advantage that the protective mechanisms for the pedestrian may be activated at the earliest possible instant, since the bumper represents a first contact point to the object.

The distance measuring device may preferably also or additionally be situated on the rear bumper in order to also detect a truck underride when backing up.

### BRIEF DESCRIPTION OF THE DRAWINGS

FIG. 1 shows a top view of the device according to the present invention.

FIG. 2 shows a side view of the device according to the present invention.

FIG. 3 shows a flow chart of a possible process within the control unit of the restraint system.

### DETAILED DESCRIPTION

A plurality of restraint systems, which should protect the occupants in the event of an accident, are presently used in some vehicles. Vehicle/vehicle accidents, roll-over accidents, side crashes, and other accident situations are predominantly covered. A plurality of sensors are utilized to recognize such accidents. The sensors are essentially configured for the purpose of recording kinematic variables such as acceleration. Appropriate ignition means are ignited in the event of too high an acceleration or too high a speed. But pre-crash systems are also known. A radar sensor, for example, which is installed on the bumper in the horizontal direction, monitors the surroundings and is to recognize future accident situations, restraint systems being triggered as a function of the signal of such a pre-crash sensor.

A different, less safety-critical system is based on ultrasonic sensor technology which is used for a parking aid. Such “parking sensors” assist the driver during the parking operation and emit a warning signal when adjacent vehicles or other obstacles are too close. The range of these sensors is approximately 70 cm to 1 m. A future object of passive protection is the expansion of pedestrian protection. Some strategies for pedestrian protection have already been mentioned, contact-based sensors in the bumper area being predominantly used. But radar-based sensors and other pre-crash sensors may also be used here.

However, it is disadvantageous that the mentioned sensors have absolutely no effect in the event of “truck underrides.” The airbag is mostly ineffective here since the mass difference is extremely high and conventional restraining means such as airbags or seat-belt tighteners do not work in these situations. Absent crash crumple zones in a truck and the inadequate conformity of the vehicle contours are to be viewed as reasons for this. In the event of a rear-end impact, the passenger car underrides the rear end of the truck with its front end. In passenger car/passenger car accidents, the crash would begin at the bumper, but not in such underride crashes. As a rule, the first contact with the truck occurs with the hood. Reliable deployment of the restraining means in a timely fashion is no longer possible and the respective sensors send signals insufficient for this purpose.

The risk of getting killed in a collision between a passenger car and a truck is three times greater than in a passenger car/passenger car crash. Two thirds of the killed passenger car occupants lose their lives in head-on collisions with a truck front end.

Therefore, it is provided according to the present invention to generate an additional input signal for restraining means which is to be included in the general underride sensor. A distance measuring device is provided which is aligned vertically to detect such a truck underride. Ultrasonic sensors, or also radar-based sensors, may be used for this purpose. These sensors should preferably be installed in the bumper area. Thus, distance measurement takes place in the z direction. The device according to the present invention should be designed in such a way that it preferably senses over the entire bumper in order to enable detection of this underride as early as possible, even in the event of a skew truck underride. The distance measuring device, i.e., the respective sensors, is typically installed in a vertical position. This results in sensing being possible in the z direction. During normal driving, no obstacle is typically to be detected in the bumper area, so that the sensors send predominantly zero signals. Should an obstacle or a truck appear in this area, the sensor then sends a signal different from zero. In combination with additional signals from different sensors, it may then unambiguously be determined which appropriate restraining means are to be ignited. Processing preferably takes place in a control unit; a possible analysis is also possible in a control unit different from the central airbag. Signals, read in in the control unit, are then appropriately processed in an algorithm and subsequently decide which protective mechanisms are to be activated.

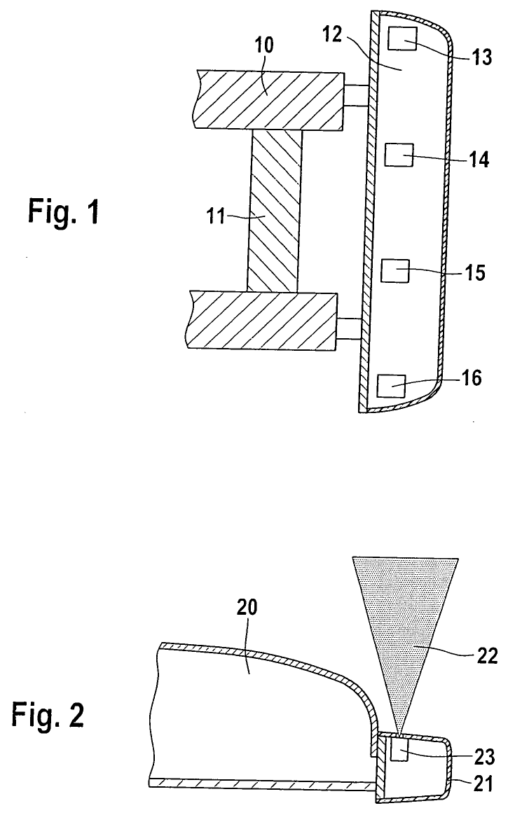

FIG. 1 shows a top view of the device according to the present invention. A bumper 12 is mounted on a longitudinal chassis beam 10 on both sides of a body. The longitudinal chassis beams are connected to one another via a cross beam 11. Bumper 12 has four vertically aligned distance measuring devices 13 through 16. These distance measuring devices are radar-based in this case. It is alternatively possible to also use ultrasonic sensors, Lidar sensors, or video sensors which are configured for distance measuring. Four sensors are used here. This enables particularly large coverage during distance measuring.

FIG. 2 shows a side view of the device according to the present invention. A bumper 21 is mounted on vehicle 20. Sensors 23, of which only one is shown, have an upward sensing area 22. Distance measuring itself takes place according to the known methods in radar systems.

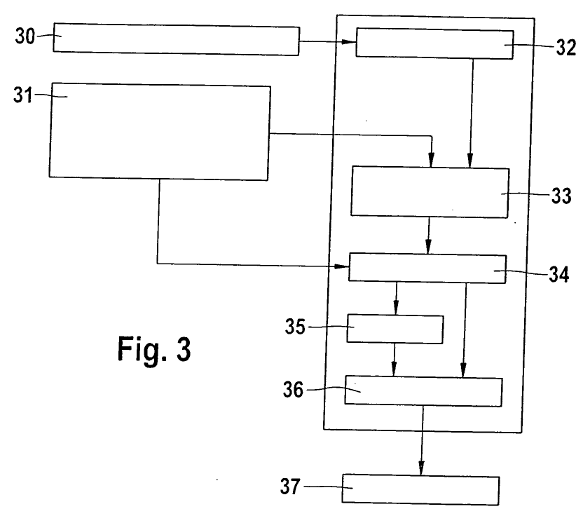

FIG. 3 shows in a flow chart how the sensor data of the distance sensors is input into a triggering algorithm. The bumper sensor data is read out in method step 30, and this data is processed and recorded in method step 32. The data is subsequently supplied to the triggering algorithm in method step 33. Additional sensor signals obtained in method step 31 are also input into the triggering algorithm. This includes signals from pre-crash sensors, acceleration sensors, and additional sensors such as pedestrian sensors or other deformation sensors. The algorithm subsequently executes the method in method step 33 and forms a triggering decision if needed. This triggering decision is subjected to a plausibility check in method step 34, sensor signals from method step 31 also being used here. A correction as a function of the plausibility check takes place in method step 35 and, in method step 36, the triggering signal is gated in a logic with the signals which were checked for plausibility. This possibly results in triggering of the restraint systems in method step 37.

1-9. (canceled)

10. A device for detecting an obstacle underride, comprising:
at least one vertical distance measuring device situated on a vehicle front in such a way to detect an obstacle underride.

11. The device according to claim 10,
wherein the vertical distance measuring device includes at least one transceiver.

12. The device according to claim 11,
wherein the at least one transceiver includes one of an ultrasonic sensor and a radar sensor.

13. The device according to claim 10,
wherein the vertical distance measuring device includes at least one video sensor.

14. The device according to claim 10,
wherein the vertical distance measuring device is situated on a bumper.

15. The device according to claim 14,
wherein the at least one vertical distance measuring device includes four vertical distance measuring devices for carrying out distance measurements at four locations on the bumper distanced from one another.

16. The device according to claim 10,
wherein the device is connectable to a control unit for restraining means in such a way that the control unit triggers the restraining means as a function of a signal of the device.

17. The device according to claim 10,
wherein the device is configured for the purpose of sensing pedestrians.

18. The device according to claim 10,
wherein the vertical distance measuring device is situated on a rear bumper.
